(19) United States
(12) Patent Application Publication
(10) Pub. No.: US 2013/0316584 A1
(43) Pub. Date: Nov. 28, 2013

(54) BUS BAR FOR FORMING FUSIBLE LINK BLOCK CIRCUIT, FUSIBLE LINK BLOCK, AND METHOD FOR MANUFACTURING FUSIBLE LINK BLOCK

(71) Applicant: YAZAKI CORPORATION, Tokyo (JP)

(72) Inventors: Naoto Taguchi, Shizuoka (JP); Masaru Shimizu, Shizuoka (JP)

(73) Assignee: YAZAKI CORPORATION, Tokyo (JP)

(21) Appl. No.: 13/958,882

(22) Filed: Aug. 5, 2013

Related U.S. Application Data
(63) Continuation of application No. PCT/JP2012/058011, filed on Mar. 27, 2012.

(30) Foreign Application Priority Data
Mar. 31, 2011 (JP) 2011-079573

(51) Int. Cl. H01R 9/24; H01R 43/18

(52) U.S. Cl. CPC H01R 9/245; H01R 43/18
USPC 439/620.26; 29/623

(57) ABSTRACT

A bus bar 10 includes integrally therewith a plurality of load side terminal boards 12 to be connected to a power supply side terminal board through their respective fusible members 13, the shapes of the fusible members are unified, temporarily connecting points are set in the intermediate portions of the fusible members in a current flow direction, the temporarily connecting points of the mutually adjoining fusible members are connected to each other by joint ribs 15 to be cut in a later step, and, by changing the cutting positions of the joint ribs to be cut in the later step, the fusing properties of the fusible members can be changed.

### CROSS REFERENCE TO RELATED APPLICATION

This application is a continuation of PCT application No. PCT/JP2012/0058011, which was filed on Mar. 27, 2012 based on Japanese Patent Application No. 2011-079573 filed on Mar. 31, 2011, the contents of which are incorporated herein by reference. Also, all the references cited herein are incorporated as a whole.

### BACKGROUND OF THE INVENTION

1. Field of the Invention

The present invention relates to a fusible link block mainly interposed between an in-vehicle battery and load side equipment and, specifically, to a bus bar for forming a circuit for a fusible link block, a fusible link block, and a method for manufacturing a fusible link block.

2. Description of the Related Art

This type of fusible link block, generally, includes a plurality of branch circuits connected to a plurality of loads, while each branch circuit is protected using a fuse. In this case, a circuit from a power supply side terminal board (which corresponds to an upstream side terminal board situated on the upstream side in a current flow direction) through fusible members respectively fulfilling fuse functions to a multi-branched load side terminal board (which corresponds to a downstream side terminal board situated on the downstream side in the current flow direction) is made of a pressed bus bar, and only the necessary portion thereof is covered with a resin-made housing, whereby the circuit is formed into a block.

FIGS. 5 to 7 show an example of the conventional technology. Specifically, FIG. 5 is a perspective view of a conventional bus bar for forming a fusible link block, showing the shape thereof after pressed, FIG. 6 is a front view of a conventional bus bar of a fusible link block, showing the structure thereof, and FIG. 7 is a front view of a fusible link block formed by integrating the bus bar of FIG. 6 with a resin housing.

This fusible link block includes a bus bar 110 serving as a circuit forming member and a resin housing 120 for partially covering the outer periphery of the bus bar 110 and the like. The bus bar 110 includes a power supply side terminal board 111 to be connected to a battery and a plurality of load side terminal boards 112 respectively connected through their associated fusible members (portions the current-flowing section areas of which are reduced and which are thereby made easy to be fused due to joule heat) 113 to the power supply side terminal board 111. Since, in the bus bar 110 including such branch circuits, a plurality of fusible members 113 can be arranged collectively and integrally, the bus bar 110 can be formed very compact. This type of bus bar is disclosed in JP-A-2004-127698.

This type of bus bar 110 is made by pressing a metal plate and can be integrated with a resin housing 120 by insert molding the resin housing 120. Or, by pressure inserting the bus bar 110 into a previously molded resin housing, the bus bar can be integrated with the resin housing.

Each fusible member 113 includes a low melting point metal placement portion 114 in its central portion in a current flow direction, while a chip of low fusing point metal such as a tin alloy is mounted on the placement portion 114 in order to stabilize the fusing property of the fusible member 113. An example in which low fusing point metal is placed in the center of the fusible member in this manner is disclosed in JP-A-2010-27545 and JP-A-2004-127701.

In the case of the bus bar 110 with low fusing point metal mounted on the fusible member 113, when a high current equal to or higher than a given current flows, the low fusing point metal fuses, and also this low fusing point metal and fusible member 113 become eutectic to form an alloy layer of a large resistance value, which promotes generation of heat by electricity to cause the fusible member 113 to fuse. The thus fused fusible member 113 cuts off the supply of an excess current to the load side equipment. The fusion of the fusible member 113 occurs on the upstream or downstream side of the low fusing point metal placement portion 114. In order to determine the fusing portion, on the fusible member 113 existing near the low fusing point metal placement 114, there is formed in the pressing stage of the bus bar 110 a narrow portion 113a produced by reducing the width of the local portion of the fusible member 113. While the narrow portion 113a is a portion which has a direct influence on the resistance value affecting the fusing property of the fusible member 113, since it is low in strength because of the reduced material width, the fusible member 113 is easy to deform when external force is applied thereto.

In view of this, in order to prevent unreasonable force from being applied to the fusible member 113 in a stage where the bus bar 110 is handled as a single part, two mutually adjoining load side terminal boards 112 are connected to each other by a joint rib 115. In the stage where the joint rib 115 is handled as a single part, it is left uncut but it is cut before the molding of the resin housing 120 or before the pressure insertion of the bus bar 110 into the resin housing 120. Also, since the joint rib 115 must have been cut positively in the completed product stage, in addition to the cutting step, as a secondarily step, there is provided a step for confirming the cutting of the joint rib 115.

In the above-mentioned prior art technology, since the joint rib 115 is set at a position (load side terminal board 112) having no relation with the narrow portion 113a, a portion for pressing the narrow portion 113a and a portion for pressing the joint rib 115 are formed separately in a metal mold for pressing the bus bar. However, although no problem is found in the joint rib 115 pressing portion when a unified shape is used, in the narrow portion 113a, each time the fusing property (which is also called rating) of the fusible member is changed, the shape of the pressing mold must be changed, which raises a problem that the load of the pressing mold is increased.

### SUMMARY OF THE INVENTION

The invention is made in view of the above-mentioned prior-art technology circumstances. Thus, it is an object of the invention is provide a bus bar for forming a circuit for a fusible link, a fusible link block and a method for manufacturing a fusible link block in which, unless other portion than a portion corresponding to the narrow portion of a fusible member is changed, the shape of a pressing mold need not be changed and thus a mold having a unified shape can be used, the productivity thereof can be enhanced.

The object of the invention is attained by the following structures.

(1) A bus bar for forming a fusible link block circuit, integrally comprising therewith an upstream side terminal board; and a downstream side terminal board situated in downstream of the upstream side terminal board in a current flow direction and connectable to the upstream side terminal board through a fusible member; wherein a temporarily connecting point is set in an intermediate portion of the fusible member in the current flow direction; the temporarily connecting point and the upstream side terminal board or the downstream side terminal board are connected to each other by a joint rib to be cut in a later step; and a fusing property of the fusible member is changeable by changing a cutting position of the joint rib to be cut in the later step.
(2) A fusible link block comprising a circuit forming bus bar including integrally therewith an upstream side terminal board and a plurality of downstream side terminal boards respectively situated in downstream of the upstream side terminal board in a current flow direction and connectable to the upstream side terminal board through their respective fusible members in order to form branch circuits from the upstream side terminal board, wherein the shapes of the fusible members are unified, temporarily connecting points are set in the intermediate portions of the fusible members in the current flow direction, the temporarily connecting points of the mutually adjoining fusible members are connected to each other by joint ribs to be cut in a later step and, by changing the cutting positions of the joint ribs to be cut in the later step, the fusing properties of the fusible members can be changed.
(3) A fusible link block according to the above article (2), wherein low fusing point metal is placed in the centers of the fusible members in the current flow direction, the temporarily connecting points are set near the placement portions of the low fusing point metal and the temporarily connecting points of the mutually adjoining fusible members are connected to each other by the joint ribs.
(4) A method for manufacturing a fusible link block, comprising: a g step for producing the circuit forming bus bar set forth in any one of the above items (1) to (3) by pressing; a housing assembling step for integrating a resin housing with the circuit forming bus bar produced in the pressing step and causing the fusible members to face the window portion of the resin housing; and, a cutting step, by inserting a cutting tool through the window portion of the resin housing after the housing assembling step, for cutting the joint ribs while adjusting the widths of the fusible members to thereby cause the portions of the fusible link block ranging from the fusible members to the downstream side terminal boards to be electrically independent of each other.

The fusible link block circuit forming bus bar having the above (1) structure can provide the following operations. That is, for example, in a stage where the circuit forming bus bar is handled as a single part, when the downstream side terminal board connected through the fusible member to the upstream side terminal board is disconnected and independent of the upstream side terminal board or other downstream side terminal boards, there is a fear that, when the fusible member forming a low strength portion is deformed due to external force, the whole arrangement relationship of the bus bar can be disturbed. On the other hand, in the bas bar for forming fusible link block circuit having the above (1) structure, since the fusible member is connected to the upstream side terminal board or downstream side terminal boards through the joint ribs to be cut in the later step, the deformation of the fusible member due to the external force can be prevented as much as possible and thus the disturbance of the whole arrangement relationship can be prevented.

Also, since, when cutting the joint ribs in the later step, the width dimension of the portion corresponding to the narrow portion of each fusible member can be adjusted freely according to the position and dimension of the punch serving as a cutting tool, the fusing property of the fusible member to be determined mainly by the dimension of the portion corresponding to the narrow portion can be adjusted easily in the later step, that is, in the cutting step not in the circuit forming bus bar pressing step. Therefore, pressing molds used when press working the circuit forming bus bar need not be prepared separately according to the different fusing properties of the fusible members but the pressing molds can be unified. Also, since the fusing properties of the fusible members can be adjusted in the cutting step such as a punching step to be executed after the pressing step, while standardizing the shapes of the fusible members in the pressing step, many variations of the fusible members having different fusing properties can be produced in the cutting step that is the later step. This can reduce greatly the intermediate stock of the bus bars before the cutting step.

Also, since the joint ribs are situated at the positions of the fusible members, when the circuit forming bus bar is assembled to the resin housing by insert molding or by pressure insertion, the cutting portion of the joint ribs can be made to face the window portion of the resin housing, whereby the cutting step for cutting the joint ribs can be set such that they are executed in a stage after the circuit forming bus bar is assembled to the resin housing. Therefore, the connecting functions by the joint ribs can be left unchanged to the end of the fusible link block producing step, which can effectively prevent the deformation of the fusible member until the circuit forming bus bar is positively fixed by the resin housing, thereby being able to enhance the quality of the fusible link block.

The fusible link block having the above (2) structure can provide the following operations. That is, for example, in a stage where the circuit forming bus bar is handled as a single part, when the plurality of downstream side terminal boards connected through the fusible members to the upstream side terminal board are separated and independent of each other, there is a fear that the fusible member forming a low strength portion can be deformed due to external force to thereby disturb the whole arrangement relation of the fusible link block. However, in the fusible link block having the above (2) structure, since the fusible members are connected to each other through the joint ribs to be cut in the later step, the deformation of the fusible members due to the external force can be prevented as much as possible and thus the disturbance of the whole arrangement relation of the fusible link block can be prevented.

Also, when cutting the joint ribs in the later step, that is, in the cutting step, the width dimensions of the portions corresponding to the narrow portions of the fusible members can be adjusted freely according to the position and dimension of the punch serving as the cutting tool. Therefore, the fusing properties of the fusible members to be determined mainly by the dimensions of the portions corresponding to the narrow portions can be adjusted easily in the later step, that is, in the cutting step not in the circuit forming bus bar pressing step. This makes it possible to standardize the dimensions of the fusible member working portions of the mold used for press working the circuit forming bus bar.

Also, since the fusing properties of the fusible members can be adjusted in the cutting step to be executed after the pressing step, while standardizing the shapes of the fusible members in the pressing step, many variations of the fusible members having different fusing properties can be produced in the later step, that is, in the cutting step. Thus, the intermediate stock of the fusible members before the cutting step can be reduced greatly.

Also, since the joint ribs are situated at the positions of the fusible members, when assembling the circuit forming bus bar to the resin housing by insert molding or by pressure insertion, the cutting portions of the joint ribs can be made to face the window portion of the resin housing, whereby the cutting step for cutting the joint ribs can be set such that it is executed in a stage after the circuit forming bus bar is assembled to the resin housing. Therefore, the connecting function by the joint rib can be left as it is to the end of the fusible link block producing step, which can effectively prevent the deformation of the fusible members until the circuit forming bus bar is positively fixed by the resin housing, thereby being able to enhance the quality of the fusible link block.

According to the fusible link block having the above (3) structure, since the low fusing point metal is disposed in the center of the fusible members, the fusing properties of the fusible members can be stabilized.

Also, since the joint ribs are connected to the vicinity of the low fusing point metal placement portions formed in the fusible members, a resistance value, that is, the fusing properties of the fusible members to be determined mainly by the width dimensions of the fusible members existing near the low fusing point metal placement portions can be adjusted easily by changing the cutting positions of the joint ribs.

According to the fusible link block manufacturing method having the above (4) structure, by changing the cutting position of the joint rib according to the position and dimension of the cutting tool, the fusing properties of the fusible members can be adjusted easily in the later step, that is, in the cutting step not in the circuit forming bus bar pressing step. This makes it possible to standardize the dimensions of the mold used when pressing the circuit forming bus bar. Also, since the cutting of the joint ribs by the cutting tool is carried out in a stage after the housing assembling step for assembling the circuit forming bus bar to the resin housing, the connecting function provided by the joint ribs can be left unchanged to the end of the fusible link block producing step, thereby being able to effectively prevent the deformation of the fusible members until the circuit forming bus bar is positively fixed by the resin housing and thus being able to enhance the quality of the fusible link block.

### BRIEF DESCRIPTION OF THE DRAWINGS

FIG. 1 is a front view of a fusible link block circuit forming bus bar according to an embodiment of the invention.

FIG. 2 is a front view of the circuit forming bus bar of FIG. 1 and a resin housing integrally assembled to such bus bar by insert molding.

FIG. 3 is a front view of a fusible link block, showing a state where joint ribs shown in FIG. 2 are cut to make the respective load side circuits electrically independent of each other, whereby the fusible link block is completed.

FIGS. 4A to 4C are respectively partial front views of the fusible link block, showing examples in which, by changing the cutting positions of the joint ribs, the widths of such portions as correspond to the narrow portions of the fusible members are changed like Ha, Hb and Hc.

FIG. 5 is a perspective view of a conventional fusible link block, showing the shape of its circuit forming bus bar after it is pressed.

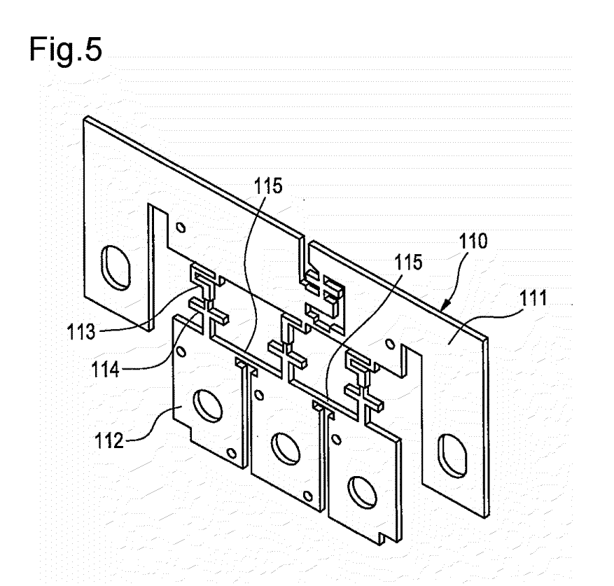

FIG. 6 is a front view of the conventional fusible link block, showing a state where low fusing point metal chips (tin alloy chips) are placed in and embraced by the low fusing point metal placement portions of the fusible members of the circuit forming bus bar of FIG. 5.

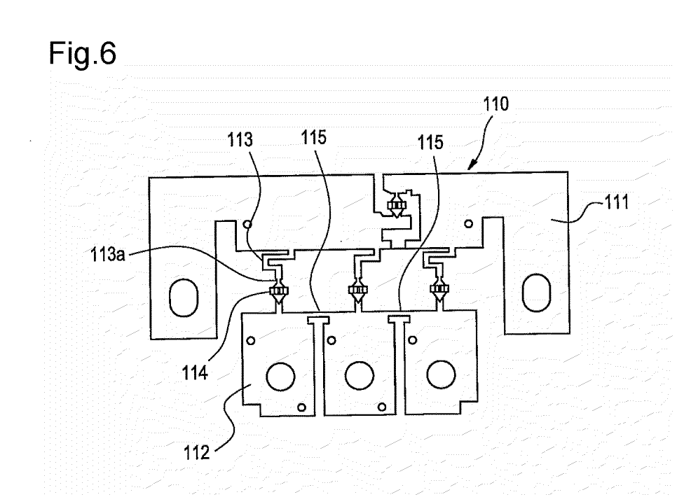

FIG. 7 is a front view of the conventional fusible link block, showing a state where the circuit forming bus bar of FIG. 6 is integrated with a resin housing by insert molding.

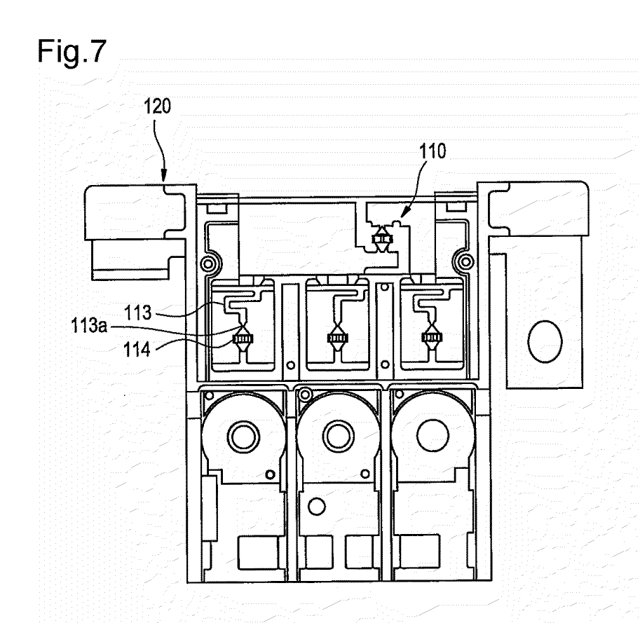

### DESCRIPTION OF THE PREFERRED EMBODIMENTS

Now, description is given below of an embodiment of the invention with reference to the accompanying drawings.

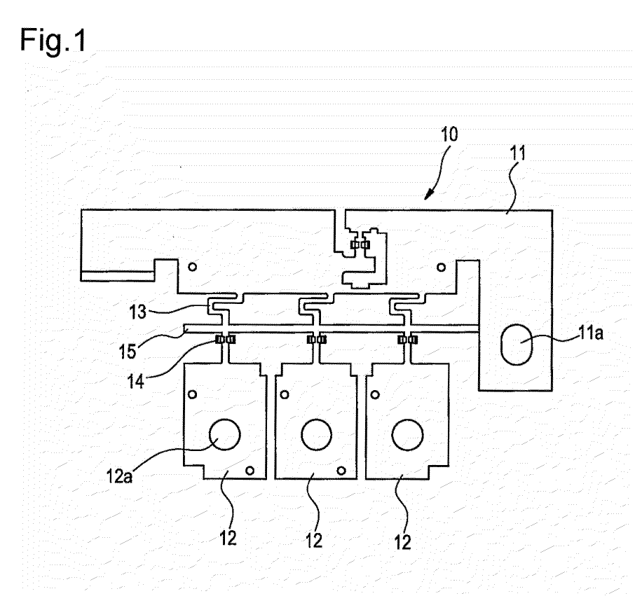

As shown in FIGS. 1 to 3, a fusible link block according to this embodiment includes a bus bar for forming a circuit (circuit forming bus bar) 10 produced by pressing a metal plate and a resin housing 20 which, after the bus bar 10 is set in a mold, is insert molded in such a manner that it covers partially the outer periphery of the bus bar 10 or the like.

As shown in FIG. 1, the bus bar 10 includes a power supply side terminal board 11 to be connected to a battery and a plurality of load side terminal boards 12 connected to the power supply side terminal board 11 through the respective fusible members 13 (portions the current-flowing section areas of which are reduced and thus which are made easy to fuse due to joule heat) in order to form branch circuits from the power supply side terminal board 11. Here, the power supply side terminal board 11 corresponds to an upstream side terminal board situated on the upstream side in a current flowing direction, and the load side terminal boards 12 correspond to downstream side terminal boards respectively situated downstream of the upstream side terminal board in the current flowing direction.

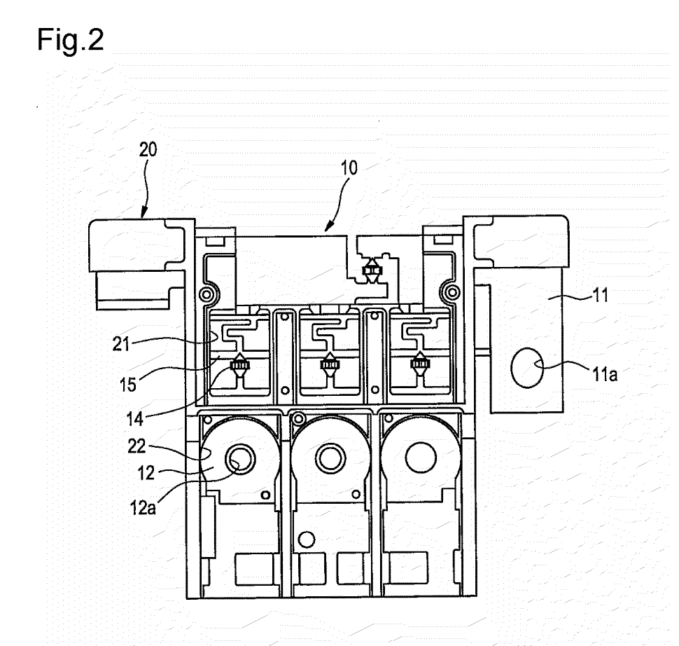

The power supply side terminal board 11 includes a connecting hole 11a for connection to a terminal provided on the power supply side and each load side terminal board 12 includes a connecting hole 12a for connection to a terminal provided on the load side. The portions of the bus bar where the connecting holes 11a, 12a and the fusible members 13 are respectively formed to be exposed from the resin housing 20. Specifically, the portions where the connecting holes 12a of the load side terminal boards 12 are respectively exposed to the outside in the first window portion 22 of the resin housing 20, while the portions where the fusible members 13 are provided are respectively exposed to the outside in the second window portion 21 of the resin housing 20 (see FIG. 2).

The load side terminal boards 12 and fusible members 13 are arranged in a row and the shapes of the fusible members 13 are unified as the same shape. Each fusible member 13 includes a temporarily connecting point in its intermediate portion in the current flow direction, while the temporarily connecting points of the mutually adjoining fusible members 13 are connected to each other by joint ribs 15 to be cut in a later step. Also, the temporarily connecting points of the fusible members 13 adjoining the L-like bent portion of the power supply side terminal board 11 and the power supply side terminal board 11 are connected to each other by a joint rib 15 to be cut in a later step. And, the joint ribs 15 are arranged on a straight line.

Also, the fusible members 13 respectively include, in their central portions in the current flowing direction, low fusing point metal placement portions 14, and tin alloy chips (designation thereof is omitted) serving as low fusing point metal chips are mounted by calking or by welding on the respective placement portions 14. The temporarily connecting points of the fusible members 13 are set near the upstream side of the low fusing point metal placement portions 14.

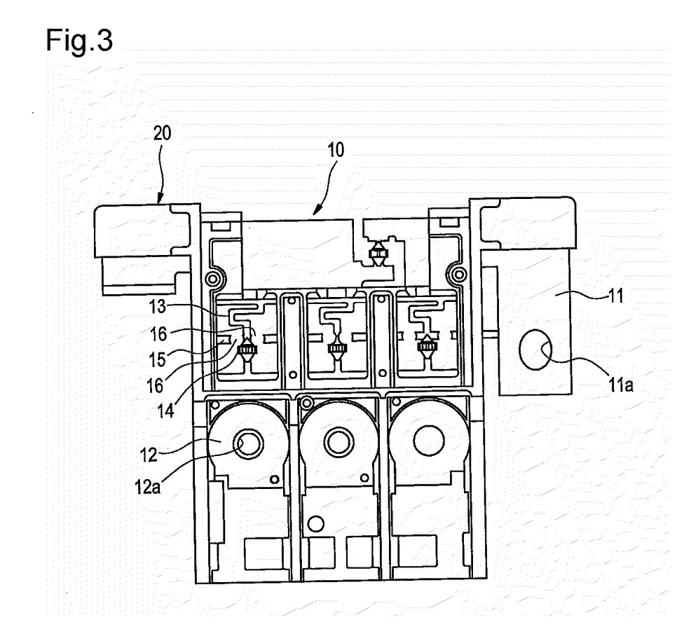

When producing the fusible link block of this embodiment, firstly, in a pressing step, the bus bar 10 having the shape shown in FIG. 1 is produced by pressing, and the low fusing point metal chips are mounted on the low fusing point metal placement portions 14. Next, to integrate the resin housing 20 with the bus bar 10 produced in the pressing step, in a housing assembling step, while the bus bar 10 is set in a mold, the resin housing 20 is insert molded. Thus, as shown in FIG. 2, the fusible members 13 are caused to face the second window portion 21 of the resin housing 20. Next, in a punching step which is a cutting step, by inserting a punch 17 serving as a cutting tool through the second window portion 21 of the resin housing 20, the joint ribs 15 are cut while adjusting the widths of the fusible members 13, whereby the ranges of the fusible link block respectively extending from the fusible members 13 to the load side terminal boards 12 are made electrically independent of each other. Thus, the fusible link block shown in FIG. 3 can be produced. In FIG. 3, the cutting portion of the joint rib 15 is designated by numeral 16.

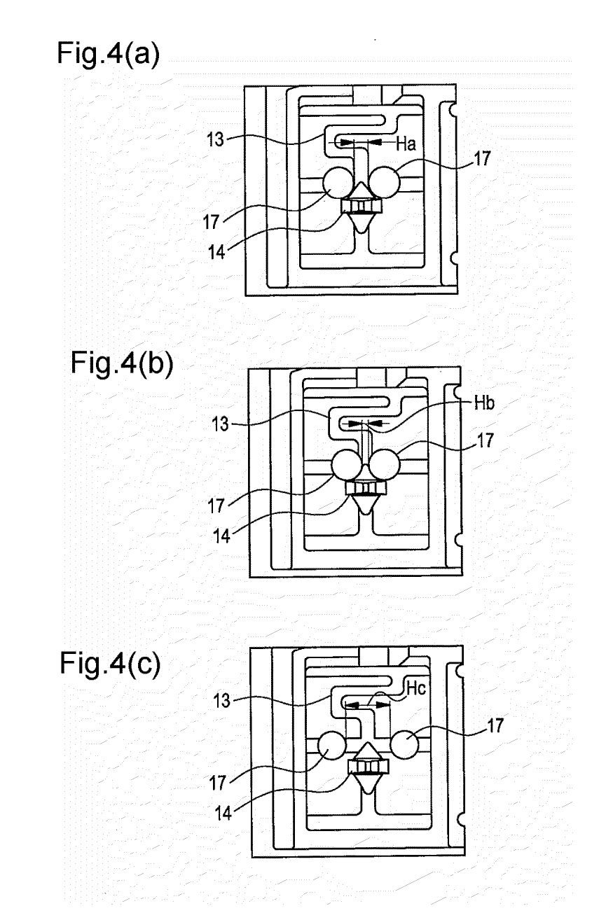

When cutting the joint ribs 15 by the punches 17 in this manner, as shown in FIGS. 4A to 4C, by adjusting the positions and shapes of the punches 17, the width dimensions of the portions corresponding to the narrow portions can be changed like Ha, Hb and Hc (where Hb<Ha<Hc) and thus the fusing properties of the fusible members 13 can be adjusted freely. For example, the width dimension Ha corresponds to an ordinary rated current, Hb to a low rated current, and Hc to a high rated current, respectively. In the three fusible members 13 arranged from left to right in FIG. 3, the fusible member on the left in FIG. 3 is used for the ordinary rated current (width dimension Ha), the central fusible member for the low rated current (width dimension Hb), and the right fusible for the high rated current (width dimension Hc).

According to the above bus bar 10, the following operation effects can be provided. That is, for example, in a stage where the bus bar 10 is handled as a single part, when the load side terminal boards 12 connected through the fusible members 13 to the power supply side terminal board 11 are separated from and thus independent of the other boards, there is a fear that, when the low-strength fusible members 13 are deformed by external force, the arrangement relation of the whole bus bar can be disturbed. However, according to the above-structured bus bar 10, since the fusible members 13 are connected to each other through the joint ribs 15 to be cut in a later step, namely, in a punching step and also are connected to the power supply side terminal board 11, the deformation of the fusible members 13 due to external force can be prevented as much as possible, thereby being able to prevent the whole arrangement relation of the bus bar against disturbance.

Also, when cutting the joint ribs 15 in the punching step, the width dimensions of the portions corresponding to the narrow portions of the fusible members 13 can be adjusted freely according to the position and dimension of the punch 17 serving as a cutting tool. Thus, the fusing properties of the fusible members 13 determined mainly by the dimensions of the portions corresponding to the narrow portions can be adjusted easily in the punching step which is a later step, not in the bus bar 10 pressing step.

Therefore, pressing molds for pressing the bus bar 10 need not be prepared separately according to the different fusing properties of the fusible members 13, but the pressing molds can be unified. Or, the dimensions of the fusible member working portions of the pressing molds can be unified. Also, since the fusing properties of the fusible members 13 can be adjusted in the punching step to be executed after the pressing step, while standardizing the shapes of the fusible members 13 in the pressing step, many variations of the fusible members 13 having different fusing properties can be produced in the later step, namely, in the punching step. This can greatly reduce the intermediate stock of the fusible members before the punching step.

Also, since the joint ribs 15 are situated at the positions of the fusible members 13, when assembling the bus bar 10 to the resin housing 20 by insert molding or by pressure insertion, the cutting portions of the joint ribs 15 can be made to face the second window portion 21 of the resin housing 20, whereby the punching step for cutting the joint ribs 15 can be set such that it is executed in a stage after a housing assembling step for assembling the bus bar 10 to the resin housing 20. Therefore, the connecting functions provided by the joint ribs 15 can be left unchanged to the end of the fusible link block producing step, thereby being able to prevent the deformation of the fusible member 13 until the bus bar 10 is fixed positively to the resin housing 20 and thus to enhance the quality of the fusible link block.

Also, since the low fusing point metal is placed in the centers of the fusible members 13, the fusing properties of the fusible members 13 can be stabilized. Also, since the joint ribs 15 are connected to the vicinity of the low fusing point metal placement portions 14 formed in the fusible members 13, a resistance value to be determined by the width dimensions of the fusible members 13 existing near the low fusing point metal placement portions 14, that is, the fusing properties of the fusible members 13 can be adjusted easily by changing the cutting positions of the joint ribs 15.

The invention is not limited to the above embodiment but various changes, improvements and the like are possible according to circumstances. And, the materials, shapes, dimensions, number, placement portions and the like of the respective composing elements of the above embodiment are arbitrary and are not limitative so long as they can attain the invention.

For example, in the above embodiment, there is shown an example in which one of the three fusible members 13 is connected to its adjoining power supply side terminal board 11 through the joint rib 15. However, when a board adjoining the fusible member 13 is the load side terminal board 12, the fusible member 13 may also be connected through the joint rib 15 to such load side terminal board 12.

Also, in the above embodiment, description has been given of an example using a plurality of fusible members 13 and a plurality of load side terminal boards 12. However, the invention can also be applied to a case using a single fusible member 13 and a single load side terminal board 12 to be connected to the fusible member 13. In this case, a temporarily connecting point formed in the single fusible member 13 and power supply side terminal board 12 or load side terminal board may be connected to each other through the joint rib 15.

Also, in the above embodiment, the low fusing point metal chip is mounted on the fusible member 13. However, the low fusing point metal chip may not always be mounted.

According to a fusible link block circuit forming bus bar, a fusible link block and a method for manufacturing a fusible link block of the invention, unless other portions than the narrow portions of the fusible members are changed, the shape of the pressing mold need not be changed but the mold having a unified shape can be used, thereby being able to enhance the productivity of the fusible link block.

What is claimed is:

1. A bus bar for forming a fusible link block circuit, integrally comprising therewith:
an upstream side terminal board; and
a downstream side terminal board situated in downstream of the upstream side terminal board in a current flow direction and connectable to the upstream side terminal board through a fusible member;
wherein a temporarily connecting point is set in an intermediate portion of the fusible member in the current flow direction;
the temporarily connecting point and the upstream side terminal board or the downstream side terminal board are connected to each other by a joint rib to be cut in a later step; and
a fusing property of the fusible member is changeable by changing a cutting position of the joint rib to be cut in the later step.

2. A fusible link block, comprising:
a circuit forming bus bar including integrally therewith an upstream side terminal board and a plurality of downstream side terminal boards respectively situated in downstream of the upstream side terminal board in a current flow direction and connectable to the upstream side terminal board through respective fusible members in order to form branch circuits from the upstream side terminal board;
wherein shapes of the fusible members are unified;
temporarily connecting points are set in intermediate portions of the fusible members in the current flow direction;
the temporarily connecting points of the mutually adjoining fusible members are connected to each other by joint ribs to be cut in a later step and;
the fusing properties of the fusible members are changeable by changing cutting positions of the joint ribs to be cut in the later step.

3. The fusible link block according to claim 2, wherein low fusing point metal is placed in centers of the fusible members in the current flow direction;
the temporarily connecting points are set near placement portions of the low fusing point metal; and
the temporarily connecting points of the mutually adjoining fusible members are connected to each other by the joint ribs.

4. A method for manufacturing a fusible link block, comprising:
a pressing step of producing the circuit forming bus bar according to claim 1 by pressing;
a housing assembling step of integrating a resin housing with the circuit forming bus bar produced in the pressing step and causing the fusible members to face a window portion of the resin housing; and
a cutting step of, by inserting a cutting tool through the window portion of the resin housing after the housing assembling step, cutting the joint ribs while adjusting widths of the fusible members so as to cause portions of the fusible link block ranging from the fusible members to the downstream side terminal boards to be electrically independent of each other.
